(19) United States
(12) Patent Application Publication
(10) Pub. No.: US 2023/0203326 A1
(43) Pub. Date: Jun. 29, 2023

(54) 3D PRINTED SILICA WITH NANOSCALE RESOLUTION

(71) Applicant: William Marsh Rice University, Houston, TX (US)

(72) Inventors: Xiewen Wen, Houston, TX (US); Boyu Zhang, Houston, TX (US); Pulickel M. Ajayan, Houston, TX (US); Jun Lou, Houston, TX (US)

(73) Assignee: William Marsh Rice University, Houston, TX (US)

(21) Appl. No.: 18/168,401

(22) Filed: Feb. 13, 2023

Related U.S. Application Data
(63) Continuation of application No. PCT/US2021/045599, filed on Aug. 11, 2021.
(60) Provisional application No. 63/064,269, filed on Aug. 11, 2020.

(51) Int. Cl. C09D 11/101; B33Y 10/00; B33Y 70/10; C09D 11/03; B82Y 30/00

(52) U.S. Cl. CPC C09D 11/101; B33Y 10/00; B33Y 70/10; C09D 11/03; B82Y 30/00

(57) ABSTRACT

Compositions and methods to 3D print high quality inorganic nanostructures from a nanocomposite ink using two-photon polymerization are provided. Methods provide capability for 3D printing inorganic silica structures with sub-200 nm resolution with controlled crystallinity and doping. The final 3D printed inorganic product is shown to be pure SiO₂, which can be in either glass or crystalline polymorph depending on the sintering process. The 3D printed fabricated products also show remarkable optical performance with the 3D printed micro-toroid optical resonators having quality factors (Q) over 10⁴. For optical applications, doping and co-doping of rare earth salts such as Er³⁺, Tm³⁺, Yb³⁺, Eu³⁺ and Nd³⁺ can be directly implemented in the printed SiO₂ structures.

### CROSS-REFERENCE TO RELATED APPLICATIONS

This Application claims priority from PCT International Application No. PCT/US2021/045599, which was filed in the United States receiving office Aug. 11, 2021, and U.S. Provisional Application No. 63/064,269, which was filed in the United States of America on Aug. 11, 2020, hereby incorporated herein by reference.

### BACKGROUND

Nanostructured inorganics have promising potential applications have drawn tremendous research attention from both fundamental and practical aspects. Silica (SiO₂) is one of the most widely used inorganics that demands fabrication methods with nanoscale resolution in fields such as micro-electronics micro-electro-mechanical systems (MEMS), and micro-photonics. To fabricate inorganic materials with desired nanostructures, complicated top-down patterning processes including thermal oxidation and chemical vapor deposition, followed by either dry or wet etching steps, were normally required.

Although mature processing techniques with high yield have been developed, these techniques involve the use of hazardous chemicals (e.g., resists, developers, etchants, etc.) and require complex facilities for fabrication. Moreover, achieving intricate and/or asymmetric three-dimensional (3D) architectures at nanometer resolution is challenging when using top-down fabrication methods. As such, there is growing demand for direct nano-manufacturing techniques which can produce 3D inorganic structures with complex geometries and chemical variabilities.

The invention was also made with private support under: Grant Number C-1716 awarded by the Robert A. Welch Foundation.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to methods that includes 3D printing inorganic nanostructures including; first preparing a nanocomposite ink comprising a solution of colloidal nanoparticles of a first material with a first photopolymer precursor and a second photopolymer precursor, a photoinitiator, and a photoinhibitor. Methods may further include applying the nanocomposite ink to a wafer; subjecting the nanocomposite ink to a focused laser to initiate two-photon polymerization (2PP) to additively form a composite comprising the nanoparticles within a polymerized network; and subjecting the composite comprising the nanoparticles within the polymerized network to pyrolysis sand sintering to form the printed 3D inorganic nanostructures comprised of the first material.

In another aspect, embodiments disclosed herein relate to a nanocomposite ink composition that's includes a mixture of colloidal functionalized silica nanoparticles; a first photopolymer precursor and a second photopolymer precursor; a photoinitiator; and a photoinhibitor.

In another aspect, embodiments disclosed herein relate to a 3D printed silica structure that includes silica in amorphous glass or polycrystalline cristobalite form, where the 3D printed silica structure includes nanostructure features that have a resolution of less than 200 nm; and where the 3D printed silica structure is doped with one or more rare elements selected from the group consisting of Er3+, Eu3+, Tm3+, Nd3+, Yb³⁺, or a combination thereof.

Other aspects and advantages of the claimed subject matter will be apparent from the following description and the appended claims.

### BRIEF DESCRIPTION OF THE DRAWINGS

FIG. 1 shows a comparative an FTIR spectrum of functionalized nanoparticles (NPs) and unfunctionalized NPs.

FIG. 2 shows a 2PP printer shaping the nanocomposite ink into designed 3D structures.

FIGS. 3A-3B shows TEM images of SiO₂.

FIG. 4 shows the final nanocomposite ink, a clean and transparent solution with light yellow color.

FIGS. 5A-5B show (FIG. 5A) SAXS data and curve-fitting for the mixture of polymer precursors and functionalized silica NPs and (FIG. 5B) SAXS determined particle diameter distribution of functionalized silica NPs in photopolymer precursors and the TEM analyzed particle diameter of colloidal silica NPs.

FIG. 6 shows the temperature vs time diagram of the pyrolysis and sintering processes.

FIGS. 7A-7I show a comparison of amorphous and crystalline silica nanostructures. Provided are bright field STEM images and diffraction pattern of printed amorphous (FIG. 7A) and crystalline (FIG. 7D) silica. FIGS. 7B and 7E show EDS mapping of 0 of printed amorphous silica and crystalline silica, respectively. FIGS. 7C and 7F show EDS mapping of Si of printed amorphous silica and crystalline silica, respectively. FIGS. 7G-7I show X-ray diffraction, X-ray photoelectron spectroscopy, and Raman spectroscopy of printed amorphous and crystalline silica, respectively.

FIGS. 8A-8E show shows optical applications of printed silica resonator. FIG. 8A shows transmission spectra of 3D printed amorphous and crystalline SiO₂. FIG. 8B shows transmission spectra of the 3D printed micro-toroid optical resonator. FIG. 8C shows fitting of quality factor at 1554.2 nm. FIG. 8D shows an SEM image of the printed micro-toroid optical resonator (scale bar: 10 μm). FIG. 8E shows photoluminescence of Er³⁺, Eu³⁺, Tm³⁺, Nd³⁺, Yb³⁺ doped and Er³⁺/Yb³⁺1:1 co-doped SiO2 crystal in the visible to near infrared range, inset: showing the Er3+ doped micro-toroid optical resonator under 495 nm (left) and 592 nm (right) excitation and observed at 519 nm (left) and 614 nm (right) using a fluorescence microscope.

FIG. 9 shows SEM images of fabricated isolated smooth lines.

FIGS. 10A-10D shows microstructures of silica printed using the proposed 2PP enabled AM technique. FIG. 10A shows FCC lattice truss structure with a scale bar of 5 μm. FIG. 10B shows diamond lattice truss structure (scale bar 10 μm). FIG. 10C shows a disk-on-truss structure (scale bar 10 μm). FIG. 10D shows a needle array (scale bar 10 μm).

FIGS. 11A-11C show SEM observations of a 3D printed octet truss structures before (FIG. 11A) and after (FIG. 11B) sintering at two different temperatures of 1100° C. and 1300° C. (FIG. 11C).

FIG. 12 shows the optical setup sketch for measuring Q value of printed micro-resonators.

### DETAILED DESCRIPTION

Specific embodiments will now be described in detail with reference to the accompanying figures. Like elements in the various figures are denoted by like reference numerals for consistency.

One or more embodiments of the present disclosure relate to the fabrication of inorganic materials with designed three-dimensional (3D) nanostructures. Embodiments disclosed herein relate fabricated 3D inorganic nanostructures and methods of fabricating inorganic material with designed nanostructures where methods are provided to print 3D inorganic nanostructures with sub-200 nm resolution and with controlled crystallinity and doping.

Further, one or more embodiments relate to nanocomposite ink compositions for printing 3D inorganic nanostructures, and methods of preparing the same, that may include functionalized nanoparticles, a plurality of photopolymer precursors, a photoinhibitor, and a photoinitiator. Additionally, in one or more embodiments, the designed 3D nanostructures may be fabricated from a nanocomposite ink that is doped with rare earth elements.

Terms such as “approximately,” “substantially,” etc., are intended to mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Similarly, the terms “can” and “may” and their variants are intended to be non-limiting, such that recitation that an embodiment can or may comprise certain elements or features does not exclude other embodiments of the present technology that do not contain those elements or features.

As referred to herein, all compositional percentages are specified as being by weight (wt %) or by moles (mol %) of the total composition, unless otherwise disclosed. Disclosures of ranges are, unless specified otherwise, inclusive of endpoints and include all distinct values and further divided ranges within the entire range.

In accordance with one or more embodiments, the following disclosure details methods and products formed from such methods, wherein produced designed 3D nanostructures are created at sub-200 nm resolution using methods of two-photon polymerization 2PP 3D printing in addition to controlled post-sintering techniques. The methods and compositions disclosed here provide for flexible capabilities in doping/co-doping of rare earth elements, as well as achieving 3D printed inorganic nanostructures with high Q values, such as micro-toroid resonators, which reveal the potential of building passive and active integrated micro-photonic chips with silica via 3D printing.

In one or more embodiments, the 3D printed product may be an inorganic material comprised essentially of silica (SiO₂) and may be in either amorphous glass or polycrystalline cristobalite, a mineral polymorph of silica, form depending on the specific method steps, specifically related to the sintering process.

Generally, additive manufacturing (AM), or 3D printing using digital designs, can be employed to fabricate fine structures through a layer-by-layer deposition to generate complex architectures and simplify fabrication processes. Further, as a well-demonstrated bottom-up technique, 3D printing can be used to construct curvilinear substrates, nonplanar surfaces, and tortuous 3D patterns which were previously beyond the capability of traditional top-down patterning methods.

It is recognized that traditional methods of fabricating silica micro-photonic components were incapable of creating arbitrary 3D structures. However, the high-resolution 2PP enabled AM technique and methods, as disclosed in herein, provide the capability for fabrication of both passive and active micro photonic components, making 3D printing of integrated photonic components feasible.

The fabricated inorganic materials prepared in accordance with one or more embodiments of the present disclosure may be characterized as possessing improved optical performance where the produced 3D silica nanostructures, such as printed micro-toroid optical resonators have quality factors (Q) over 10⁴. Additionally, for optical applications, the 3D printed structures comprised of inorganic materials may be doped and/or co-doped to further comprise rare earth salts such that can be directly implemented in the produced inorganic material structures. As a result, the as-printed doped crystals, prepared in accordance with one or more embodiments of the present disclosure, demonstrate strong photoluminescence at the desired wavelengths.

In one or more embodiments, methods may include the use of 2PP to achieve sub-wavelength spatial resolution. Two-photon polymerization (2PP) is a laser-based direct writing technology in which a resin initiates free radical polymerization by absorbing two photons simultaneously. The two-photon absorption process is able to overcome the optical limit of illumination, and as a result, sub-wavelength spatial resolution can be readily achieved. Inorganic 3D printed nanostructures produced in accordance with one or methods provided herein using 2PP techniques greatly extend the potential application range of 2PP AM.

Conventionally, microstructures produced using 2PP may suffer from less controllable crystallinity, poor thermal tolerance as well as optical transparency, all of which will hinder their applications in microelectronics and micro-photonics. To address these limitations, methods are provided in one or more embodiments to 3D print inorganic silica comprising nanostructures with controlled crystallinity and doping at sub-200 nm resolution. Methods generally involve 2PP enabled AM of monodispersed functionalized colloidal inorganic nanoparticles (NPs), such as silica nanoparticles, followed by pyrolysis and sintering, where the processing temperature may be tailored to selectively alter the crystallinity of the produced structures.

As shown in one or more embodiments, successful loading of a specified amount of inorganic nanoparticles into a precursor photopolymer mixture results in a nanocomposite ink that may be printed into 3D inorganic nanostructures with improved printed geometry and minimal deformation. It is successfully demonstrated that with the inorganic material added, the thermal tolerance of as-printed 3D nanostructures is enhanced, thus enabling high temperature processing.

However, in fabricating designed 3D printed nanostructures of the present disclosure, a loading threshold must be considered as the printing resolution and capability of 2PP enabled AM are sensitive to the optical properties of the photopolymer precursor of the nanocomposite ink. While loaded inorganic materials have an impact on the photo absorption, the nanosized colloidal NPs provide several advantages including minimizing photo extinction and scattering to make the photopolymer processable using 2PP method. The inclusion of nanosized colloidal nanoparticles also enables a sub-micro resolution (˜200 nm) by decreasing the size of the starting nanoparticles. They also provide a high-temperature post-treatment capability by increasing the ceramic loading amount and introduce a larger surface energy which can trigger the recrystallization process at a relatively lower treatment temperature. The first two aspects enable nanoscale resolution 3D printing using 2PP method, while the latter two ensure the capability to tune the crystallinity of the produced nano or microstructure while maintaining the quality of the as-designed structure.

Accordingly, the following disclosure details methods and compositions for forming inorganic 3D nanostructured products, wherein the produced printed inorganic 3D structures are of amorphous glass or polycrystalline cristobalite form which may be created at sub-200 nm resolution using 2PP 3D printing and post-sintering methods of one or more embodiments provided herein. Methods disclosed herein further provide flexible capabilities in doping/co-doping of rare earth elements, as well as achieving high Q-value printed silica nanostructures. The methods and the product components and properties are detailed as follows.

### Nanocomposite Ink

In one or more embodiments, methods for fabricating 3D silica nanostructures may include a nanocomposite “ink” which includes inorganic nanoparticles (NPs) and a two-photon polymerizable precursor mixture. Such ink must meet several conditions. First, the size of silica NPs must be small (about 10 nm) in order to achieve nanoscale resolution. Second, the refractive index of the photopolymer precursor mixture must match that of silica to obtain transparent ink to eliminate photo extinction and scattering. Third, the heat conductivity of the nanocomposite ink must be high to avoid instant vaporization by the femtosecond laser with megawatts of peak power. Fourth, the nanocomposite ink must be homogeneous and well-dispersed to maintain nanoscale resolution as well as to avoid localized vaporization. Fifth, the mass loading of the inorganic NPs should be high to maintain the printed geometry and minimize deformation. It is further considered that while using smaller NPs is necessary to achieve high resolution, sub-micron size particles can result in an undesirable mixture with high viscosity, which in turn makes mechanical mixing difficult. Additionally, high viscosity also leads to low heat conductivity because viscosity is normally inversely proportional to heat conductivity.

To address these competing factors, the nanocomposite ink disclosed in one or more embodiments includes a first step of functionalizing the inorganic nanoparticles. Specifically, the nanocomposite ink of one or more embodiments includes polyethylene glycol (PEG) functionalized well-dispersed colloidal silica NPs in addition to a mixture of two small molecule acrylate precursors where the PEG functional groups are chemically attached to the colloidal silica NPs.

Additionally, the mixture of polymer precursors is selected such that the precursor mixture has the same refractive index as silica and can be fully removed during any subsequent annealing processes. As such, mixing colloidal silica NPs, polymer precursors and any other additives, such as a photo-initiator and/or photoinhibitor, can produce well-dispersed nanocomposite ink with the silica NPs size down to 10 nm with high loading (40 wt %), low viscosity, high transparency, and high heat conductivity.

As introduced above, one or more embodiments of the present disclosure are directed to a nanocomposite ink including PEG-functionalized colloidal NPs. The functionalized NPs may be comprised entirely or essentially of silica.

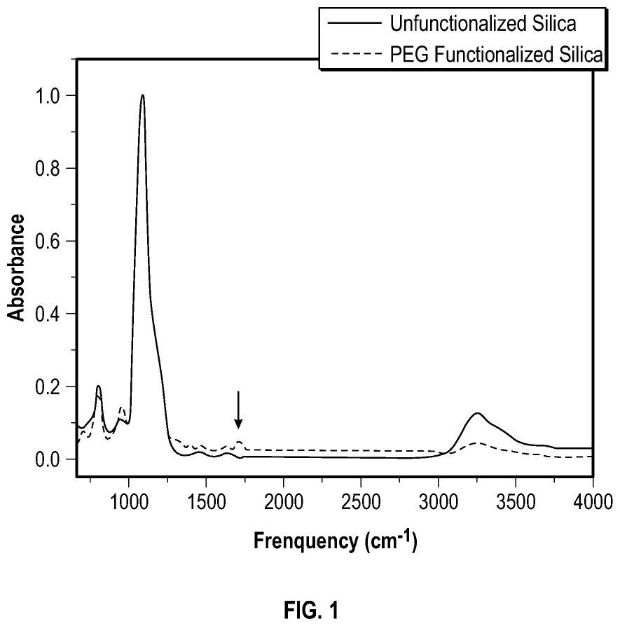

As shown in FIG. 1, an FTIR spectrum of dried functionalized NPs shows the presence of PEG functional groups at the surface of the silica nanoparticles. FIG. 1 further confirms that a new peak emerges at 1703 cm⁻¹, which corresponds to the stretching vibration of carbonyl groups from PEG.

In one or more embodiments, the average particle diameter of the silica NPs may range from a lower limit selected from 5, 8, 10, 15, 20, 25 and 30 nm, to an upper limit selected from 8, 10, 12, 16, 20, 30, 40, and 50 nm, where any lower limit may be paired with any mathematically-feasible upper limit.

In one or more embodiments, the nanocomposite ink may include the silica NPs in a range from a lower limit selected from 20, 25, 30, 35, 40, 45, 50, and 55 percent by weight (wt %), to an upper limit selected from 30, 35, 40, 45, 50, 55, and 60 wt %, where any lower limit may be paired with any mathematically-feasible upper limit.

In one or more embodiments the nanocomposite ink may include photopolymer precursors where the photopolymer precursors are small molecule acrylates. In one or more embodiments, suitable acrylate photopolymer precursors may include those with a molecular weight of less than 10,000 grams per mole. In some embodiments, the acrylate photopolymer precursors, or mixture thereof in cases with more than one, may be a liquid at room temperature and have a refractive index of about 1.5. In one or more embodiments, the suitable photopolymer precursors are selected from those that are composed of carbon, oxygen, and hydrogen and where the photopolymer precursors can participate in free radical reactions.

For example, in one or more embodiments, the photopolymer precursors may be one or more selected from the list including trimethylolpropane ethoxylate triacrylate, poly (ethylene glycol) diacrylate, pentaerythritol tetraacrylate, ethylene glycol diacrylate, trimethylolpropane ethoxylate triacrylate, 2-hydroxyethyl methacrylate, pentaerythritol triacrylate, or a combination thereof. Additionally, in some embodiments, the photopolymer precursors may contain the same PEG functional group as the colloidal silica NPs to ensure that the silica NPs have excellent miscibility and dispersity in the polymer precursors. Additionally, the mixture of polymer precursors may have the same refractive index as silica NPs.

In one or more embodiments, the nanocomposite ink may include a combination of the photopolymer precursors such that there is first and a second photopolymer precursor. The first and second photopolymer precursors may both be comprised in the nanocomposite ink at a ratio, relative to each other, that ranges from 1:3 to 3:1. For example, in one or more embodiments, the first and second photopolymer precursors may both be comprised in the nanocomposite ink at a ratio, relative to each other, that ranges from 1:3 to 1:2, 1:3 to 2:1, 2:1 to 3:1, or 1:2 to 3:1, respectively. The nanocomposite ink may comprise the one or more photopolymer precursors, such as a first and second photopolymer precursors, in a range from a lower limit selected from 40, 45, 50, 55, 60, 65 and 70 wt % to an upper limit selected from 45, 50, 55, 60, 65, 70, 75, and 80 wt %, where any lower limit may be paired with any mathematically-feasible upper limit.

In one or more embodiments, the nanocomposite ink may include one or more additives such as photoinitiators and/or photoinhibitors. For example, in some embodiments, the nanocomposite ink may include a photoinitiator where the photoinitiator may be, but is not limited to, one or more selected from list of 4,4′-bis (diethylamino) benzophenone, 2-benzyl-2-(dimethylamino)-4′-morpholinobutyrophenone, phenylbis(2,4,6-trimethylbenzoyl)phosphine oxide, Diphenyl(2,4,6-trimethylbenzoyl)phosphine oxide, acetophenone, thioxanthen-9-one, 2-benzyl-2-(dimethylamino)-4′-morpholinobutyrophenone, or a combination thereof.

In one or more embodiments, the nanocomposite ink may include the photoinitiator in an amount ranging from 0.1, 0.2, 0.4, 0.6, 1.0, 1.3, and 1.5 wt % to 0.3, 0.5, 0.7, 1, 1.2, 1.5, 1.8 and 2.0 wt %, where any lower limit may be paired with any mathematically-feasible upper limit.

In one or more embodiments, the nanocomposite ink may include a photoinhibitor where the photoinhibitor may be any polymerization inhibitor that is capable of dissolving in the photopolymer precursor or mixture thereof. For example, in one or more embodiments, the photoinhibitor may be one or more selected from a list including hydroquinone, 4-methoxyphenol, mequinol, butylated hydroxytoluene, quinone methide, or a combination thereof.

In one or more embodiments, the nanocomposite ink may include the photoinitiator in an amount ranging from 0.05, 0.08, 0.10, 0.20, 0.30, 0.40, 0.50 and 0.60 wt % to 0.10, 0.15, 0.20, 0.30, 0.40, 0.50, 0.60, 0.80, and 1.00 wt %, where any lower limit may be paired with any mathematically-feasible upper limit.

In one or more embodiments, the 3D printed structures comprised of inorganic materials may be doped and/or co-doped to further comprise one or more rare earth salts of Er³⁺, Tm³⁺, Yb³⁺, Eu³⁺ and Nd³ such as erbium (III) chloride hexahydrate, ytterbium (III) chloride hexahydrate, thulium (III) chloride hexahydrate and europium (III) chloride hexahydrate, Neodymium (III) chloride hydrate, or a combination thereof.

In one or more embodiments, the nanocomposite ink may include one or more rare earth salts in an amount ranging from 1.0, 1.5, 2.0, 2.5, and 3.0 wt % to 2.0, 2.5, 3.0, 3.5, 4.0, and 5.0 wt %, where any lower limit may be paired with any mathematically-feasible upper limit.

### Preparation of Nanocomposite Ink

In one or more embodiments, the nanocomposite ink may be prepared by mixing one or more acrylate monomers with functionalized silica NPs. In some embodiments, the nanocomposite ink may be prepared by mixing two acrylate monomers functionalized silica NPs.

For example, in one or more embodiments, the nanocomposite ink may be prepared by first mixing a first photopolymer, such as trimethylolpropane ethoxylate triacrylate, with a second photopolymer, such as polyethylene glycol diacrylate, at a ratio of 1:2 respectively. The mixture of the first and second photopolymer may be mixed by magnetic stirring at room temperature. Next, a solution of functionalized NPs, such as SiO₂, may be slowly added into the mixture under magnetic stir. After the mixture becomes clear and transparent, a polymerization inhibitor, such as hydroquinone, may be added to mixture to inhibit the reaction of the photopolymer precursors. The mixture comprising the first and second photopolymer precursors and functionalized silica NPs may be kept in a vacuum drying oven at about 60° C. for about 2 hours to ensure that the solvent has completely evaporated. Following the evaporation of the solvent, a photoinhibitor, such as 4,4′-Bis (diethylamino) benzophenone, may be added to the mixture. The prepared precursor mixture may then be subjected to sonication for about 30 minutes until the resulting solution becomes transparent.

As noted, the nanocomposite ink of one or more embodiments may further include dopants or co-dopants. To prepare the nanocomposite ink precursor mixture for rare earth element doped nano-precursor, rare earth salts may be selectively added to the precursor before the photoinitiator is added. Sonication may then be applied to accelerate the dissolving process. Additionally, in a case where erbium chloride may be added, a step of adding ethylene glycol may also be selectively used to help dissolve the erbium chloride in the nanocomposite ink mixture.

### 3D Printing Method

In one or more embodiments, the nanocomposite ink comprised of silica nanoparticles and a photopolymer precursor mixture may be used to fabricate 3D nano- or microstructures via 2PP additive manufacturing. The 3D nanostructures may be fabricated by using a commercial two photon polymerization additive-manufacturing system (Nanoscribe Photonic Professional GT).

This process may include a 2PP additive-manufacturing system equipped with an oil immersion mode objective lens to perform the printing. In one or more embodiments, steps may include first sonicating a substrate or wafer, such as a sapphire wafer, in acetone and the rinsing the wafer with isopropanol alcohol to clean the surface and to mitigate potential for adhesion of the nanocomposite ink to the surface of the substrate. The wafer may then be cleaned with O₂ plasma for to fully remove any contamination.

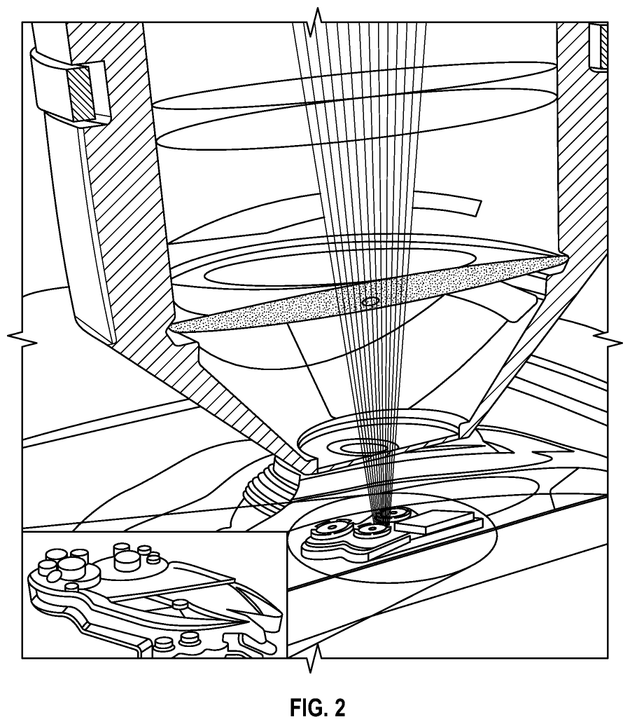

Next, the nanocomposite ink may be applied to the substrate, such as the sapphire wafer, and loaded in the Nanoscribe additive-manufacturing machine. During the printing process, laser power and laser scanning speed may be set, relative to the specific type and concentration of the photoinitiator, between 5-100 mW and 1-100 mm/2, respectively. For example, in one or more embodiments, the laser power and the scanning speed may set at 15-20 mW and 4-5 mm/s, respectively. FIG. 2 illustrates a 2PP printer shaping the nanocomposite ink into designed 3D structures. Additively forming layers of sliced structures by scanning the galvanometer transversely and moving the z-axis with the piezoelectric stage such that the final desired structures are printed.

After the printing process is completed, the wafer may then be immersed in a solution, such as propylene glycol monomethyl ether acetate (PGMEA) to dissolve any un-polymerized precursor and then immersed in isopropanol alcohol to remove any residual PGMEA. Next, a 100 W UV LED lamp can be optionally used to further solidify the printed structure. Finally, the sample may be immersed in isopropanol alcohol and dried out using, for example, a critical point dryer, to avoid collapsing of printed microstructure due to surface tension of solvent.

### Pyrolysis and Sintering

The fabricated 3D micro and nanostructures printed in accordance with one or more embodiments presently disclosed demonstrate that the final 3D printed product is of pure SiO₂. It is further demonstrated that by tuning the sintering temperatures, SiO₂ nano or microstructures can be fabricated in either amorphous glass or polycrystalline cristobalite form, providing for tunability of the optical properties of the printed structures.

In one or more embodiments, a heat treatment may be used to remove the polymer, sinter the silica nanoparticles, and alter the crystallinity of the produced structures, where the silica NPs are converted into dense silica with different phase, depending upon the specific temperature treatment steps. In accordance with one or more embodiments disclosed herein, the heat treatment process can be carried out in a tube furnace with nitrogen as a protection gas under low pressure.

Prior to heat treatment, several gas purge cycles may be carried out to remove the contaminants and reactive gases in the tube. Methods may next include a temperature program where the temperature can be set to rise from room temperature to settled temperature at a speed of 1° C./min. In one or more embodiments, when the temperature reaches each of 300° C., 600° C., 1000° C., and 1100° C. where it may be held for about 180 minutes, about 120 minutes, about 500 minutes and about 180 minutes, respectively, in the case where an amorphous final 3D nanostructure is desired. The temperature treatment may also serve to ensure effective pyrolysis, sinter and recrystallize results.

In some embodiments, where a crystalline form may be obtained, the final temperature may be further raised to 1300° C., rather than 1100° C., and the hold time may be increased to 240 minutes. Following the temperature treatment, the furnace may be slowly cooled down to room temperature with the speed of −2° C./min to prevent crack during the cooling process.

### Printed 3D Structure

In one or more embodiments, the formed printed 3D nanostructures fabricated in accordance with one or more embodiments of the present disclosure may be characterized as follows.

In one or more embodiments, the formed printed 3D nanostructures fabricated in accordance with one or more embodiments of the present disclosure may comprised of dense pure silica in amorphous glass or polycrystalline cristobalite form. It was determined that the finest

The fabricated 3D inorganic nanostructures may be formed in arbitrary tailorable shapes with a resolution of about 170 nm in width, revealing that the proposed technique can achieve a resolution of sub-200 nm. The fabricated 3D inorganic nanostructures prepared in accordance with the methods disclosed herein were revealed homogeneous linear shrinkage of about 20% or less, or 15% or less, which can be attributed to the higher loading concentration and good dispersity of the NPs which support the backbone of the as-printed structure to mitigate deformation. In one or more embodiments, the formed 3D inorganic nanostructures may be high Q micro-toroid resonators.

The 3D printed inorganic nanostructures were demonstrated to be highly transparent within the measured range between 200 nm to 1100 nm where no visible absorption peaks were observed. In some embodiments, the fabricated 3D inorganic nanostructures possess high optical performance and have a quality factor (Q) of over 10⁴. As noted, in one or more embodiments, 3D printed inorganic nanostructures may be prepared by doping the nanocomposite ink with rare earth elements. The resulting nanostructures prepared with rare earth elements are shown to include said rare earth elements with concentrations of 1×10¹⁹ ions/cm³.

### EXAMPLES

With the successful preparation of the nanocomposite ink and employing 2PP printing methods, as disclosed in one or more embodiments, the final 3D printed product, demonstrated herein is shown to be of pure silica with sub-200 nm resolution.

Using methods including silica-based nanocomposite inks to fabricate 3D inorganic nanostructures with controlled crystallinity, it is further demonstrated that micro-toroid optical resonators fabricated using the present methods have quality factors (Q) over 10⁴. Moreover, it is further shown that doping and co-doping of rare earth salts such as Er³⁺, Tm³⁺, Yb³⁺, Eu³⁺ and Nd³⁺ can be directly implemented in the printed silica structures. The as-printed doped structures demonstrated strong photoluminescence at the desired wavelengths, as observed for Er³⁺, which exhibited photoluminescence around 1.55 μm.

### Sample 1A-Preparation of Nanocomposite Ink

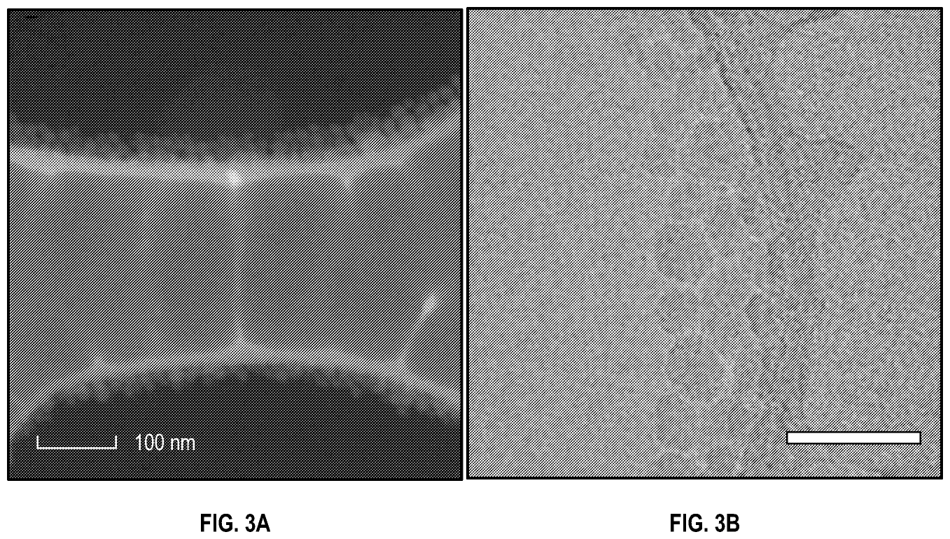

A solution of PEG-functionalized well-dispersed colloidal silica NPs with an average diameter of 11.5 nm, as shown in TEM images of FIGS. 3A and 3B, is mixed with trimethylolpropane ethoxylate triacrylate (333 mg) and polyethylene glycol diacrylate (666 mg) and then mixed with magnetic stir at room temperature for 5 minutes. Next, 5 mg of hydroquinone, a photoinhibitor, was added to the mixture and then kept in a vacuum drying oven at 60° C. for 2 hours to totally evaporate the solvent. In a final step, 10 mg of 4,4′-bis (diethylamino) benzophenone, a photo-initiator which has a large two-photon absorption cross-section at 780 nm, was added the mixture and the prepared nanocomposite ink precursor was sonicated for 30 minutes until the resulting solution became transparent.

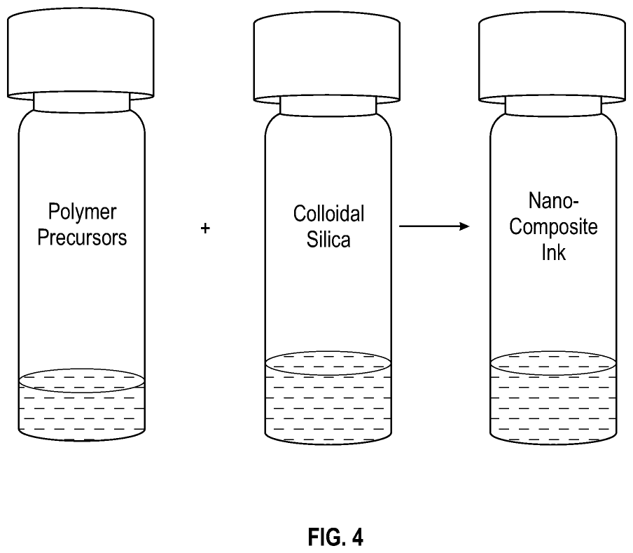

After removing the solvent from the mixture, the final nanocomposite ink, a clean and transparent solution with light yellow color, was produced as shown in FIG. 4 inset. The as-synthesized nanocomposite ink can be stored in the dark and can be kept stable for months without noticeable aggregation or settlement of silica NPs.

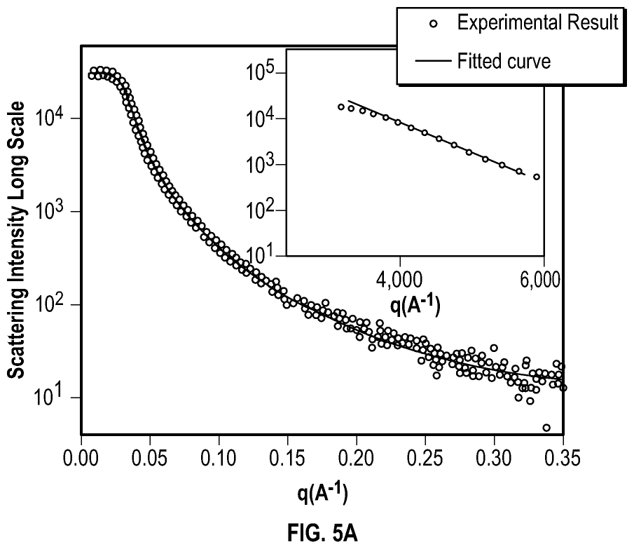

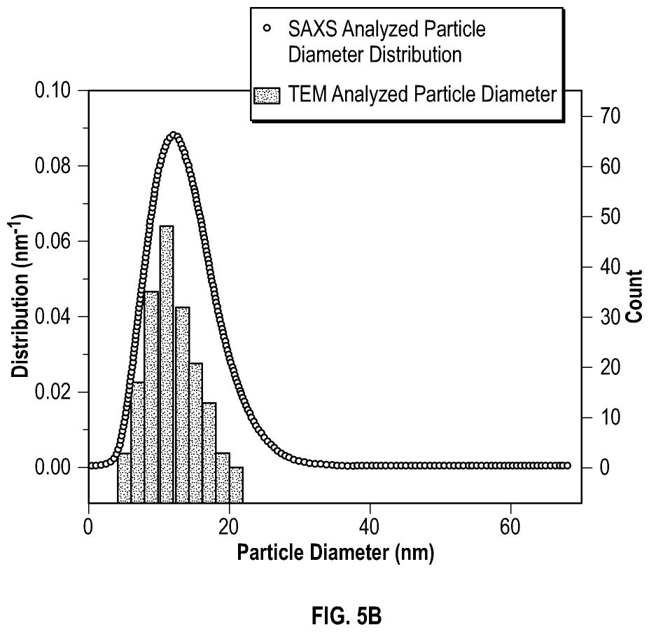

Small-angle X-ray scattering (SAXS) test were conducted on the nanocomposite ink, and the result of those tests indicate that the silica NPs are well-dispersed in the polymer precursors. Specifically, to verify the dispersity of silica NPs in nanocomposite ink, a mixture of polymer precursors and silica NPs (40 wt %) was measured and analyzed with SAXS. As shown in FIGS. 5A-5B, the SAXS curve with background subtracted was well fitted. From this, the distribution of silica NPs could be determined, as shown in FIG. 5B. The average diameter of the silica NPs was 13.67 nm and the associated size distribution RSD was 35%, which was consistent with the TEM analyzed particle diameter distribution determined in FIG. 5B. The nearest neighbor distance was calculated to be 17.7 nm.

### Sample 1B-Fabrication of 3D Nanostructure

The prepared nanocomposite ink of Sample 1A was deposited onto a sapphire substrate that had been plasma cleaned and pre-treated with sanitizer, producing a surface with moderate adhesion to the printed materials. Next, the substrate and nanocomposite ink was loaded in the Nanoscribe additive-manufacturing machine. During the printing process, laser power and laser scanning speed were set to be 15-20 mW and 4-5 mm/s, respectively.

After the printing process, the wafer was then immersed in PGMEA for 5 minutes to dissolve any un-polymerized precursor and then immersed in isopropanol alcohol for 5 minutes to remove any residual PGMEA. Next, a 100 W UV LED lamp was used to further solidify the printed structure. Finally, the sample was immersed in isopropanol alcohol and dried out using a critical point dryer to avoid collapsing of printed microstructure due to surface tension of solvent.

FIG. 2 illustrates a 2PP printer shaping the nanocomposite ink into designed 3D structures. In this process, a 780 nm, 100 fs laser beam is focused using a high numerical aperture oil immersive objective lens. The photo-initiator simultaneously absorbs two photons from the laser pulse and generates free radicals to initiate the polymerization process of the nanocomposite ink. In this step, the nanocomposite ink containing polymer precursors and silica NPs can be converted into a polymerized network with silica NPs. Due to the existence of the threshold effect in 2PP, sub-wavelength critical resolution is achieved.

Additionally, by scanning the galvanometer transversely and moving z-axis with the piezoelectric stage, layers of sliced structures are additively formed, and a final desired nanostructure may be printed.

### Sample 1C-Pyrolysis and Sintering

The as-printed polymer/silica NPs composite is then subjected to pyrolysis followed by sintering in a tube furnace in accordance with one or more embodiments disclosed above.

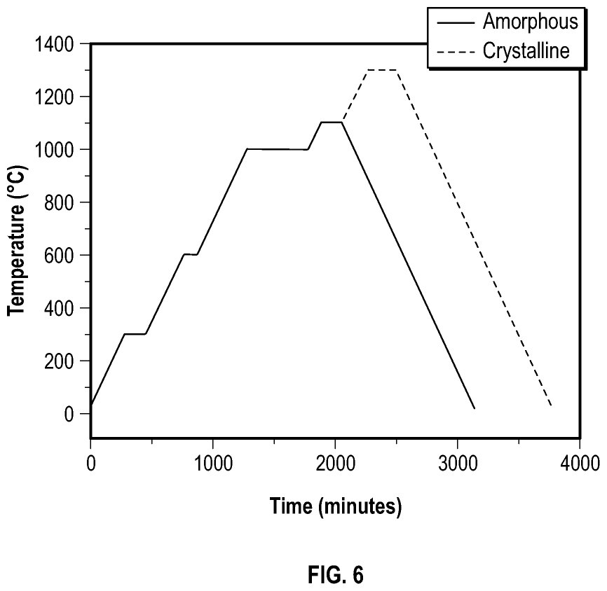

Prior to heat treatment, several gas purge cycles were carried out to remove the contaminants and reactive gases in the tube. Next, a temperature program was initiated and the temperature was programmed to rise from room temperature to specific temperature stages at a speed of 1° C./min. When the temperature reaches each of 300° C., 600° C., 1000° C. it was held for 180 minutes, 120 minutes, 500 minutes and 180 minutes, respectively, in the case where an amorphous final 3D nanostructure was produced. In Examples where a crystalline form may be desired, the final temperature may be further raised to 1300° C., rather than 1100° C., and the hold time may be 240 minutes. Following the temperature treatment the furnace was then slowly cooled down to room temperature with the speed of −2° C./min to prevent crack during the cooling process. An exemplary temperature vs time curve is provided in FIG. 6 to demonstrate the temperature program, as described above.

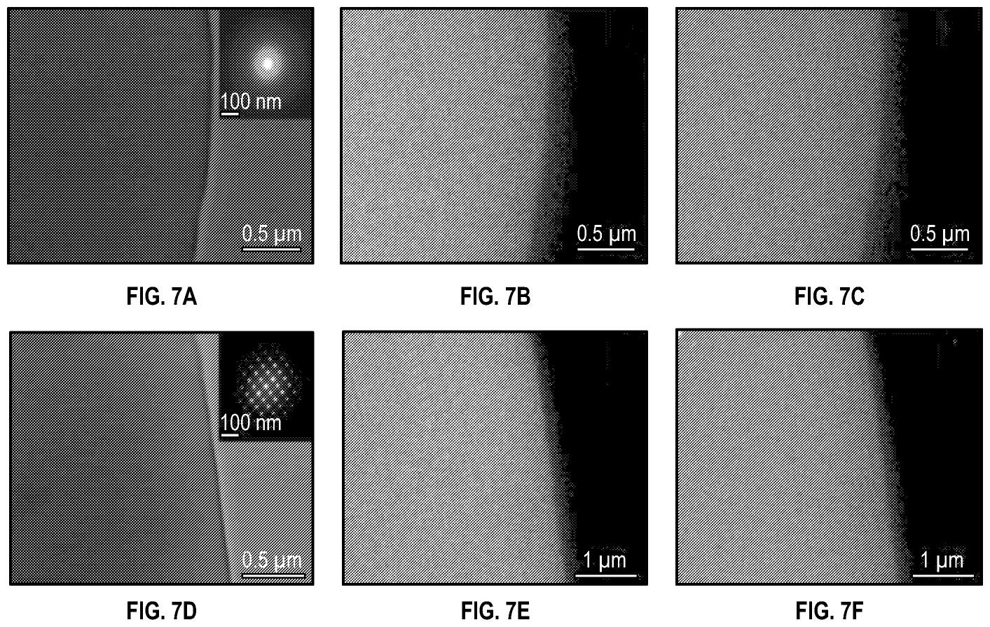

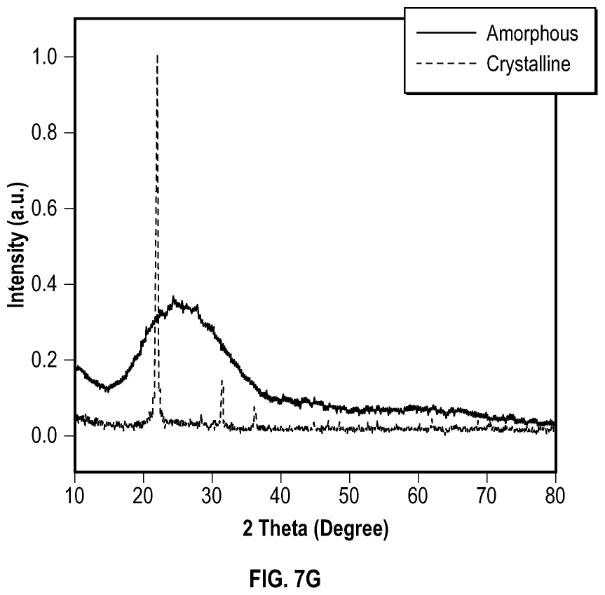

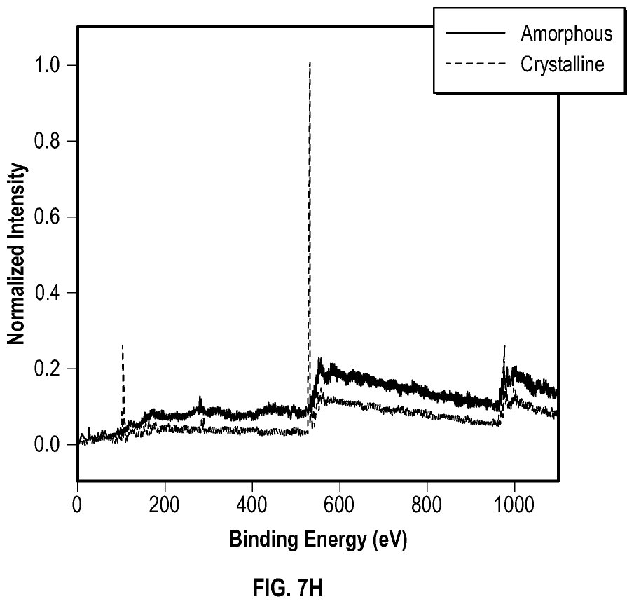

During the temperature treatment, the organic substance in the product was decomposed and removed after heat treatment, leaving only aggregated silica NPs. As the temperature increases, silica NPs were converted into dense silica with different phases. In the present Example, it was revealed that sintering at 1100° C. and 1300° C. can produce high quality amorphous glass and polycrystalline cristobalite respectively, as shown in FIGS. 7A-7I. Specifically, FIGS. 7A-7I show bright field STEM images and diffraction pattern of printed amorphous (FIG. 7A) and crystalline (FIG. 7D) silica. FIGS. 7B and 7E show EDS mapping of 0 of printed amorphous silica and crystalline silica, respectively. FIGS. 7C and 7F show EDS mapping of Si of printed amorphous silica and crystalline silica, respectively. FIGS. 7G-7I show X-ray diffraction, X-ray photoelectron spectroscopy, and Raman spectroscopy of printed amorphous and crystalline silica, respectively.

### Characterization of 3D Printed Nanostructures

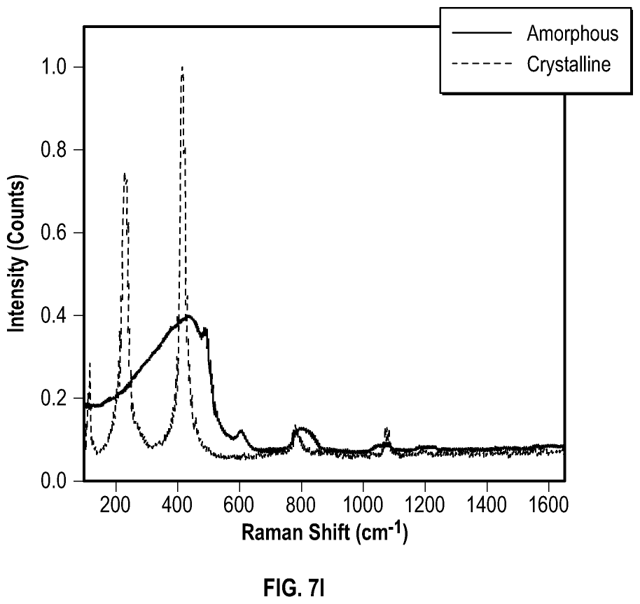

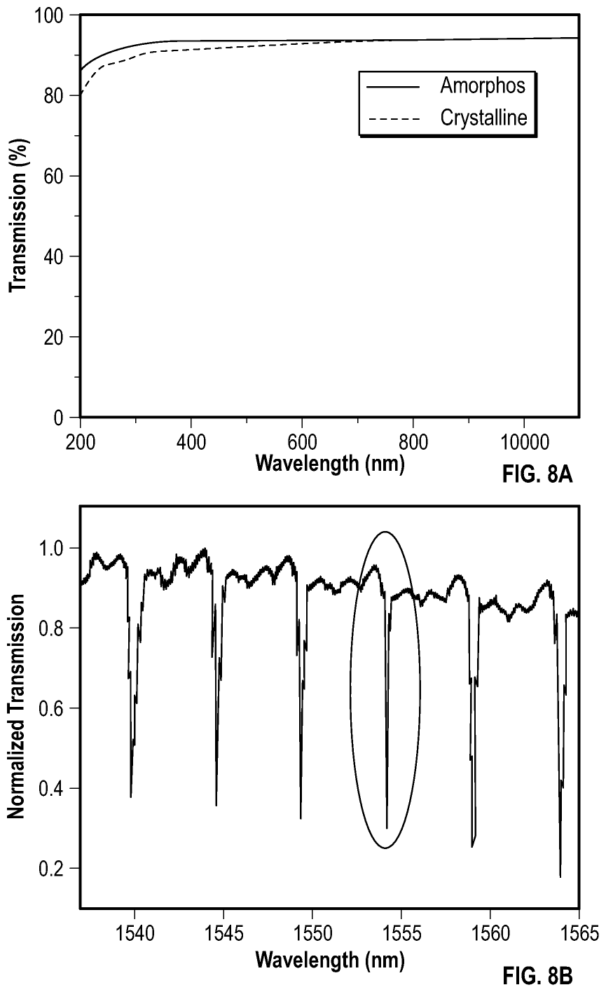

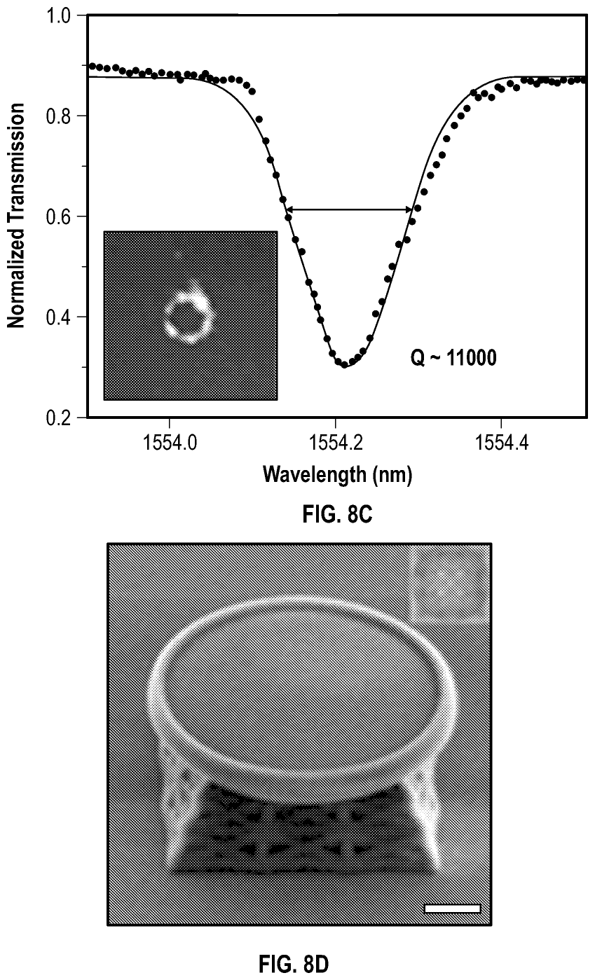

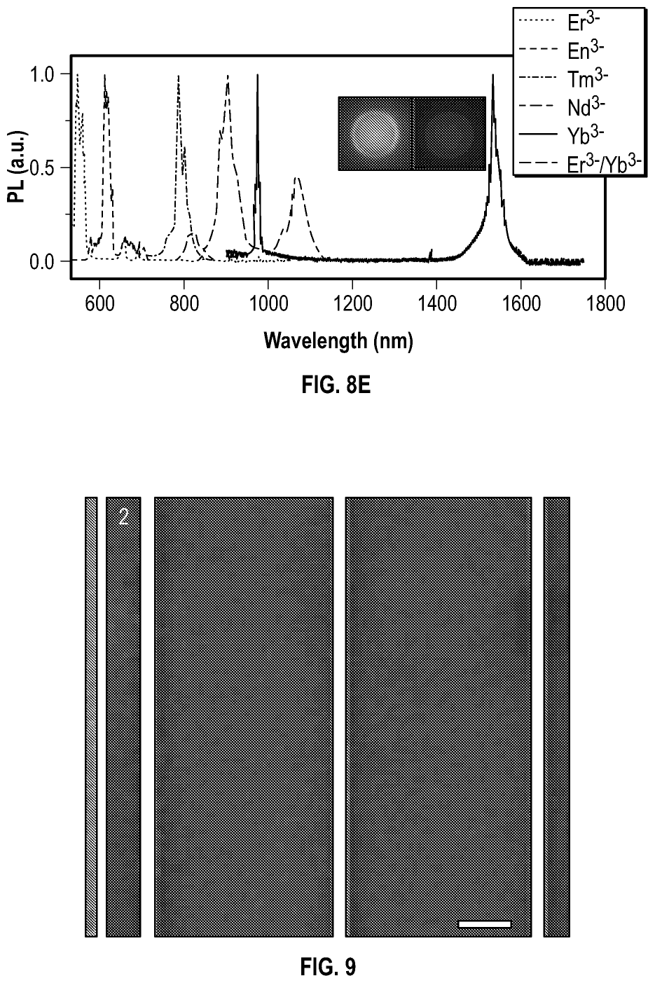

TEM observation of the colloidal silica was carried out using FEI Titan Themis3. STEM characterization of printed materials was done with JEOL 2100. XRD analysis was completed with Rigaku D/Max Ultima II. PHI Quantera XPS was used to measure the XPS spectra. UV-Visible transmission spectrum in FIG. 8A was measured using a Cary 50 UV-Vis Spectrophotometer. Raman spectroscopy of the printed materials and photoluminescence of Er³⁺, Eu³⁺, Tm³⁺, Nd³⁺, Yb³⁺ doped and Er³⁺/Yb³⁺1:1 co-doped SiO₂ crystal were measured using Renishaw confocal Raman spectrometer under 532 nm or 785 nm excitation. Optical microscopic images 8D, and the fluorescence image in FIG. 8E were measured with Zeiss LSM 710 Confocal microscope.

To investigate the finest critical resolution, printed isolated smooth lines were fabricated and imaged via SEM, as shown in SEM image is in FIG. 9. It was determined that the finest structure has a resolution of about 170 nm in width, showing that the present methods for fabricating an inorganic 3D nanostructure can achieve a resolution of sub-200 nm.

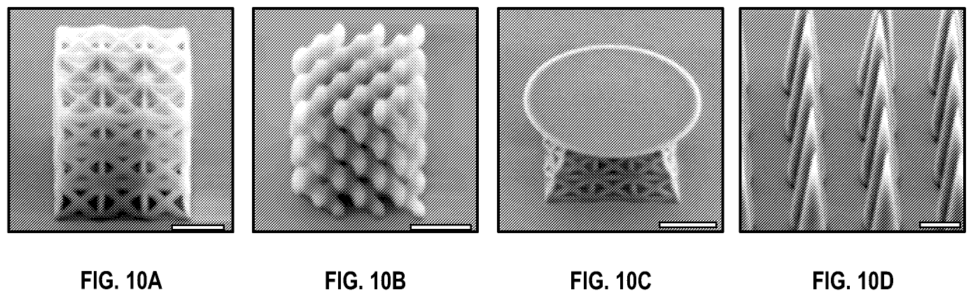

FIGS. 10A-10D display SEM images of various printed 3D structures and from these SEM images it can be seen that the intricate structures with sub-200 nm resolution can be created. Specifically, a 3×3×3 face cubic center (FCC) lattice truss structure (FIG. 10A) composed of beams with width of 400 nm and a diamond lattice truss structure (FIG. 10B) with ellipsoid features of about 1 μm diameter were highlighted, presenting improved printing capability. More intricate structures such as a suspended disk-on-truss optical resonator with a disk diameter of 25 μm (FIG. 10C) and micro needle arrays with sharp tips (FIG. 10D) can also be successfully fabricated.

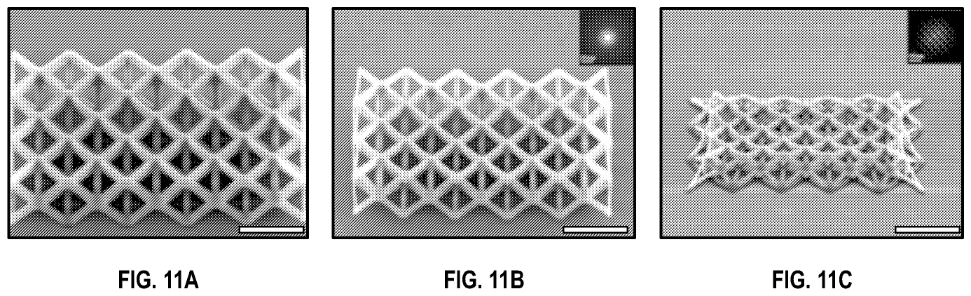

SEM observations of a 3D printed octet truss structures before and after sintering at two different temperatures of 1100° C. and 1300° C. were compared, as shown in FIGS. 11A-C, to inspect the shrinkage and deformation induced by sintering, as the shrinkage degree is critical to maintain the as-designed structure and important for further optimization.

Direct comparison between an as-sintered octet truss lattices at 1100° C. (FIG. 11B) with their as-printed counterpart (FIG. 11A) revealed homogeneous dimensional shrinkage of ˜15%. The shrinkage degree was significantly smaller than whats been achieved in other methods using stereolithography. The improvement that's results from the present methods and composition can be attributed to the higher loading concentration of nano precursors which can greatly support the backbone of as-printed structure.

However, it was also determined that sintering at 1300° C. will induce large deformation resulting in collapse of the as-designed structure, possibly due to the melting process before recrystallization and the thermal expansion mismatch between the sample and the substrate. To investigate this further, the resulting microstructure and crystallinity, specifically the crystalline phase and elemental composition of sintered silica were further confirmed by TEM, XRD and Raman spectra (FIG. 7I). It can be seen from the bright field STEM images in FIGS. 7A and 7D that the printed silica structures are dense with no observable pores or cracks, while the EDS mapping in FIGS. 7B-7F show homogeneous distributions of Si and O elements. The diffraction patterns of the two samples pertaining to amorphous and well-crystallized phases agree well with the X-ray diffraction (XRD) and Raman spectroscopy displayed in FIG. 7G and FIG. 7I. Additionally, X-ray photoelectron spectroscopy (XPS) shown in FIG. 7H confirms that the printed materials are pure silica with correct stoichiometric ratio for both samples.

### Optical Application

Silica is a transparent material which may be broadly applied in optical applications such as optical fibers, lenses and micro photonic components. To explore the unique capabilities of 2PP printed structures, UV-visible transmission spectra of the printed amorphous and crystalline thin films with a thickness of around 2 μm were measured, as plotted in FIG. 8A. The spectra indicate that the 3D printed silica materials are highly transparent within the measured range between 200 nm to 1100 nm without any visible absorption peaks. The printed amorphous silica exhibits overall higher transmission.

Generally, traditional methods of fabricating silica micro photonic components are limited when it comes to fabricating arbitrary 3D structures. However, the high-resolution 2PP enabled AM methods of one or more embodiments of the present disclosure provide the capability to fabricate both passive and active micro photonic components, making 3D printing of integrated photonic components feasible.

Whispering gallery resonators are one of the fundamental components of integrated photonics.

### Sample 2

### Fabrication and Characterization of Micro-Toroid Optical Whispering Gallery Resonator

Sample 2 is a 3D fabricated micro-toroid optical whispering gallery resonator working at the 1550 nm optical communication band (FIG. 8D). The micro-toroid optical whispering gallery resonator was fabricated according to the method disclosed above as demonstrated in Samples 1A-1C.

Compared to common techniques, which employ optical lithography and XeF₂ plasma etching to make a suspended disk followed by forming the toroid by CO₂ laser reflow, the 3D printed silica optical micro-toroid resonator on a tapered FCC lattice truss scaffold base offers multiple advantages. First, the structure of the supporting base can be made more mechanically robust by proper design, while conventional methods employ etching of the supporting structure that could not be controlled. Second, in the methods disclosed in one or more embodiments of the present disclosure the morphology of the toroid can be controlled precisely, while in conventional methods, CO₂ laser reflow is not controllable, especially for disks with large diameter.

Thus, by precisely manipulating the toroid morphology, the present methods, disclosed in one or more embodiments, provide fabricated resonators with different morphologies and high Q.

### Ring Resonator Q Value Measurement

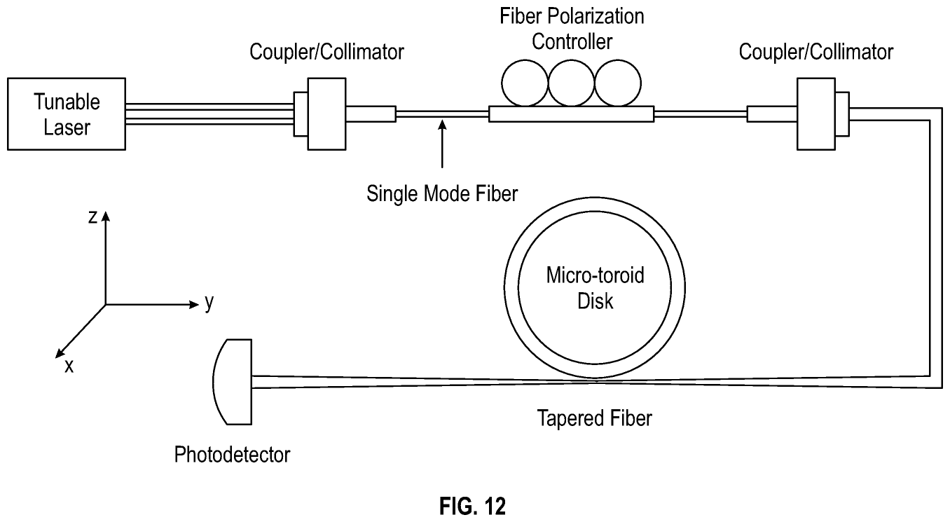

To optically characterize the fabricated microdisks and vertical micro-toroid cavities, the setup shown in FIG. 12 was used to measure the transmission spectrum.

A biconically tapered fiber with waist diameter of about 1.5 μm, which was fabricated by immersion into 48% hydrofluoric acid for 70 min, provided efficient coupling with the cavities. For the optical measurements, a single-mode tunable laser (Ando AQ4321D, 1520 nm-1620 nm) was initially launched into the tapered fiber and used to evanescently excite the whispering gallery modes (WGMs) in the microdisk and vertical micro-toroid cavities. The tunable laser was periodically scanned within 1540 nm to 1570 nm with step size of 20 pm to measure the transmission spectrum. And the polarization of the light was adjusted by using the fiber polarization controller to enhance or suppress the TE/TM polarized WGMs.

The transmitted light was then collected by a photodetector (Multi-Function Optical Meter 1835-C, Newport), which was subsequently imported into the computer to generate the transmission spectrum curve. The tapered fiber was attached and precisely aligned by a three-axis micromanipulator with a resolution of 100 nm to approach the resonator.

One camera (InGaAs SWIR SU320KTS-1.7RT, Goodrich) attached on microscope with an objective (Plan Fluor 20X/0.45, Nikon) from the top and another camera (Imagingsource DFK 72BUC02) with an objective (Nikon 10X/0.30) from the side were used to monitor their relative positions and the coupling state. After carefully adjusting the relative positions of the tapered fiber and the cavity, the WGMs could be efficiently excited and the transmission spectrum was then collected by the photodetector.

The measured normalized transmission spectrum of the fabricated micro-toroid resonator is shown in FIG. 8B. The Q factors is defined by Q=λ/Δλ, where λ is the resonance wavelength and Δλ is the FWHM (full width at half maximum). The Q factors are calculated by measuring the line width/FWHM of the Lorentzian-fitted resonance in the transmission spectrum as shown in FIG. 8C. According to the measured FWHM of the resonator, the calculated Q value is ˜11000, which is limited by material loss and surface scattering and can be further improved by optimizing the fabrication process and light coupling setup.

Measurements of the fabricated micro-disk structure with zero toroid width shown in FIG. 10C indicate a quality factor (Q) of 5×10³. FIG. 8B further shows the transmission property of the 3D printed micro-toroid resonator around 1550 nm, a standard resonance response with 4.8 nm free spectrum range. As fitted with Lorentzian line-shape, at 1554 nm the quality factor reaches 1.1×10⁴, which is comparable to the reported suspended SiO₂ optical resonators fabricated using the 2PP technique. Accordingly, using nanocomposite inks prepared in accordance with one or more embodiments, it has been demonstrated that micro-toroid optical resonators fabricated using the present methods have quality factors (Q) over 10⁴.

Furthermore, in one or more embodiments, active photonic devices were fabricated by doping the nanocomposite ink with rare earth elements. FIG. 8E shows the visible to near infrared photoluminescence of as-printed Er³⁺, Eu³⁺, Tm³⁺, Nd³⁺, Yb³⁺ doped and Er³⁺/Yb³⁺1:1 co-doped amorphous silica film with concentrations of 1×10¹⁹ ions/cm³. Each photoluminescence peak matches the atomic transition lines of individual rare earth elements, and the inset images captured with fluorescence microscope indicate that the doping is homogenous, suggesting that the proposed technique is ideal for printing active micro photonic devices such as micro lasers. The final doped silica glass nanostructure demonstrated strong photoluminescence at the desired wavelengths. Particularly for Er³⁺, where the final printed structures exhibit photoluminescence around 1.55 μm, making the proposed technology a powerful tool for optical telecommunication applications.

Furthermore, the proposed technique is the only method reported for fabricating rare earth doped micro optical components with arbitrary shapes. Although 2PP of polymer structures have been reported for active micro photonic devices by doping with organic dyes, their emission spectra are too broad for actual applications and the stability of polymer under high laser irradiation is non-trivial.

Accordingly, methods for fabricating inorganic 3D nanostructures, as provided in one or more embodiments of the present disclosure, employ 2PP 3D printing techniques using high loading of PEG-functionalized silica NPs to fabricate high quality 3D silica structures with arbitrary shapes in both amorphous and cristobalite form. The methods may be used to fabricate nanostructures at sub-200 nm resolution using the 3D printing and post-sintering techniques of one or more embodiments.

This method demonstrated flexible capabilities in doping/co-doping of rare earth elements, as well as achieving high Q micro-toroid resonators, revealing the potential of building passive and active integrated micro-photonic chips with silica via 3D printing.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

What is claimed as new and desired to be protected is:

1. A method for 3D printing inorganic nanostructures comprising:
preparing a nanocomposite ink comprising a solution of colloidal nanoparticles of a first material with a first photopolymer precursor and a second photopolymer precursor, a photoinitiator, and a photoinhibitor;
applying the nanocomposite ink to a wafer;
subjecting the nanocomposite ink to a focused laser to initiate two-photon polymerization (2PP) to additively form a composite comprising the nanoparticles within a polymerized network;
subjecting the composite comprising the nanoparticles within the polymerized network to pyrolysis sand sintering to form the printed 3D inorganic nanostructures comprised of the first material.

2. The method of claim 1, wherein the first material is silica such that the nanoparticles are silica nanoparticles.

3. The method of claim 2, wherein the silica nanoparticles have an average diameter of 5 nm to 50 nm.

4. The method of claim 1, wherein the silica nanoparticles are functionalized with polyethylene glycol.

5. The method of claim 2, wherein the formed printed 3D inorganic nanostructures are pure silica.

6. The method of claim 1, wherein the pyrolysis sand sintering comprises a temperature program where the temperature is increased to stages of 300° C., 600° C., 1000° C., and 1100° C. and held for about 180 minutes, about 120 minutes, about 500 minutes and about 180 minutes at each stage, respectively, wherein the formed printed 3D inorganic nanostructures are in amorphous glass form.

7. The method of claim 1, wherein the pyrolysis sand sintering comprises a temperature program where the temperature is increased to stages of 300° C., 600° C., 1000° C., and 1300° C. and held for about 180 minutes, about 120 minutes, about 500 minutes and about 240 minutes at each stage, respectively, wherein the formed printed 3D inorganic nanostructures are in polycrystalline cristobalite form.

8. The method of claim 1, wherein the nanocomposite ink and the formed printed 3D inorganic nanostructures comprise one or more rare earth salts selected from the group consisting of Er³⁺, Tm³⁺, Yb³⁺, Eu³⁺, Nd³⁺, or a combination thereof.

9. The method claim 2, wherein the nanocomposite ink comprises the colloidal silica nanoparticles in an amount ranging from 20 wt % to 60 wt %, with respect to the nanocomposite ink.

10. A nanocomposite ink composition comprising:
a mixture of colloidal functionalized silica nanoparticles;
a first photopolymer precursor and a second photopolymer precursor;
a photoinitiator; and
a photoinhibitor

11. The composition of claim 10, wherein the first photopolymer precursor and the second photopolymer precursor are not the same, and are each selected from the group consisting of trimethylolpropane ethoxylate triacrylate, pentaerythritol tetraacrylate, ethylene glycol diacrylate, trimethylolpropane ethoxylate triacrylate, 2-hydroxyethyl methacrylate, pentaerythritol triacrylate, or a combination thereof.

12. The composition of claim 10, wherein the nanocomposite ink comprises the first and second photopolymer precursors at a ratio, relative to each other, that ranges from 1:3 to 3:1.

13. The composition claim 10, wherein the nanocomposite ink comprises the first photopolymer precursor and the second photopolymer precursor in an amount ranging from 40 wt % to 80 wt %, with respect to the nanocomposite ink.

14. The composition claim 10, wherein the photoinitiator is one or more selected from the group consisting of 4,4′-bis (diethylamino) benzophenone, 2-benzyl-2-(dimethylamino)-4′-morpholinobutyrophenone, phenylbis(2,4,6-trimethylbenzoyl)phosphine oxide, Diphenyl(2,4,6-trimethylbenzoyl)phosphine oxide, acetophenone, thioxanthen-9-one, 2-benzyl-2-(dimethylamino)-4′-morpholinobutyrophenone, or a combination thereof.

15. The composition claim 10, wherein the photoinhibitor is one or more selected from the group consisting of hydroquinone, 4-methoxyphenol, mequinol, butylated hydroxytoluene, quinone methide, or a combination thereof.

16. The composition of claim 10, wherein the nanocomposite ink comprises one or more rare earth salts selected from the group consisting of Er³⁺, Tm³⁺, Yb³⁺, Eu³⁺, Nd³⁺, or a combination thereof.

17. The composition of claim 10, wherein the nanocomposite ink comprises the colloidal silica nanoparticles in an amount ranging from 20 wt % to 60 wt %, with respect to the nanocomposite ink.

18. A 3D printed silica structure comprising:
silica in amorphous glass or polycrystalline cristobalite form, wherein the 3D printed silica structure comprises nanostructure features that have a resolution of less than 200 nm;
wherein the 3D printed silica structure is doped with one or more rare elements selected from the group consisting of Er³⁺, Eu³⁺, Tm³⁺, Nd³⁺, Y³⁺, or a combination thereof.

19. The 3D printed silica structure of claim 18, wherein the 3D printed structure has no visible absorption peaks in the range between 200 and 1100 nm

20. The 3D printed silica structure of claim 18, wherein the 3D printed structure has a linear shrinkage rate of 20% or less when compared to the structure prior to sintering.
